(19) United States
(12) Patent Application Publication
(10) Pub. No.: US 2008/0220786 A1
(43) Pub. Date: Sep. 11, 2008

(54) Methods and Apparatus for Adaptively Selecting a Channel

(75) Inventor: Gordon B. Beacham, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/682,073

(22) Filed: Mar. 5, 2007

(51) Int. Cl. H04Q 7/20

(52) U.S. Cl. 455/450

(57) ABSTRACT

A system assesses channel conditions for a plurality of channels. The system maintains a history of channel information for the plurality of channels. The system enables communications on a channel from the plurality of channels, based on the channel conditions, and the history of channel information for the plurality of channels. The system provides an operator with at least one of channel conditions, and the history of channel information.

### BACKGROUND

Conventional technologies for Voice over Internet Protocol (VoIP) telephony over 802.11 wireless local area networks use unlicensed spectrum in the 2.4 GHz Industrial, Scientific, and Medical (ISM) band. ISM bands provide a segment of the radio spectrum that is available to anyone without a license. Devices operating within the ISM band generate in-band traffic and in-band interference.

The ISM band is populated with numerous products such as 802.11b/g/n access points, Bluetooth devices, cordless phones, cordless mice, RFID tags, 802.15.4 (Zigbee) devices, PS3 and Xbox 360 console gaming controllers, TiVo DVRs, home control, monitoring devices, microwave ovens, etc., in addition to the primary devices in the band (i.e., magnetic resonance imaging devices, etc).

### SUMMARY

Conventional technologies for channel selecting by devices operating within the ISM band, such as access points, suffer from a variety of deficiencies. In particular, conventional technologies for channel selecting are limited in that access points automatically select an operating channel based on quietest in-band traffic, for example, listening for the fewest number of beacons from other access points. Access points may periodically scan for in-band traffic, only when idle, to see if another channel has less traffic, and some access points may avoid microwave interference. Access points, for example, those in the five GHz band, listen only for radar interference per regulatory requirements. Conventional technologies for channel selecting by access points do not select a channel dynamically based on both in-band traffic and in-band interference, along with channel history. Additionally, there are no mechanisms for reporting interference information to an operator.

Embodiments disclosed herein significantly overcome such deficiencies and provide a system that includes a computer system executing an adaptive channel selecting process that dynamically adapts to in-band traffic and in-band interference conditions in, for example, a home coverage cell, based on traffic and interference signatures. Channel conditions (i.e., in-band traffic and in-band interference) are stored in a history of channel information (i.e., a historical database), along with interference signatures. The access point uses the adaptive channel selecting process to determine an optimal channel both upon startup, and at a configurable period (whether during an idle period or when a device is in use). Periodically, the adaptive channel selecting process scans a plurality of channels on the access point to identify channel conditions, and records the channel conditions within the history of channel information. In an example embodiment, the adaptive channel selecting process assesses a level of operability for at least one channel. In another example embodiment, the adaptive channel selecting process detects communications traffic and/or communications interference on at least one channel. As the adaptive channel selecting process scans the plurality of channels on the access point identifying new information, the adaptive channel selecting process updates the history of channel information.

The adaptive channel selecting process weights the interference signatures (stored within the history of channel information) interference strength that is maintained for various in-band devices and sources of in-band interference. Examples of in-band devices and sources of in-band interference include, but are not limited to 802.11b/g/n access points, Bluetooth devices, cordless phones, cordless mice, RFID tags, 802.15.4 (Zigbee) devices, PS3 and Xbox 360 console gaming controllers, TiVo, DVRs, home control and monitoring devices, microwave ovens, etc. Embodiments disclosed herein reduce trouble calls due to in-band traffic, and dynamic in-band interference. Embodiments disclosed herein also provide operators with a pro-active interference reports. Interference reports notify the operators of interference levels in home coverage cells, allowing the operators to take corrective action.

The history of channel information maintains interference signatures for all operating channels for an access point. The history of channel information is dynamically updated as soon as in-band devices and sources of in-band interference are detected, for example, at a configurable interval. The adaptive channel selecting process intelligently selects an operating channel, for example, either when idle or in-call, based on current channel conditions weighted with data maintained within the history of channel information. The adaptive channel selecting process adapts to devices competing for the same channels by adaptively switching channels when detecting, for example, when a microwave and a cordless phone are attempting to operate on the same channel. In this situation, the adaptive channel selecting process switches one of the devices to a different channel that is available. The adaptive channel selecting process establishes a switching threshold at which the adaptive channel selecting process automatically switches a device to another channel. In an example embodiment, the adaptive channel selecting process notifies an operator of changing interference conditions at a subscriber location. This allows the service provider to take proactive action to ascertain the nature of interference in the home coverage cell, and to consider alternative avoidance solutions (i.e., upgrading the subscriber to beam forming, MIMO, etc, that may resist/avoid the new interference source).

In an example embodiment, the adaptive channel selecting process anticipates usage demand on a channel based on prior demand information stored within the history of channel information.

The adaptive channel selecting process assesses channel conditions for a plurality of channels, and maintains a history of channel information for the plurality of channels. The adaptive channel selecting process enables communications on a channel from the plurality of channels, based on the channel conditions, and the history of channel information for the plurality of channels. The adaptive channel selecting process provides an operator with information associated with the channel conditions and/or the history of channel conditions.

During an example operation of one embodiment, the adaptive channel selecting process, operating on an access point, detects two devices competing for the same channel (located on the access point). The adaptive channel selecting process determines that one device is a cordless phone, and the other device is a computer. The adaptive channel selecting process determines that, based on a communications traffic threshold established for that channel, one of the devices should be switched to another channel. The adaptive channel selecting process accesses data (associated with the channel, the cordless phone and the computer) within the history of channel information. This data can include, for example, the application type (i.e., cordless phone, computer, etc.) accessing the channel. Using this information, the adaptive channel selecting process determines the computer can be safely switched to a different channel since any communications (i.e., packets) that are dropped during the switch, will be re-sent. The adaptive channel selecting process switches the computer to a new channel, leaving the cordless phone operating on the original channel, without any disruption of service.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein as embodiments disclosed herein.

It is to be understood that the system disclosed herein may be embodied strictly as a software program, as software and hardware, or as hardware alone. The features disclosed herein may be employed in data communications devices and other computerized devices and software systems for such devices such as those manufactured by Motorola, of Schaumburg, Ill.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows example embodiment according to one embodiment disclosed herein.

FIG. 2 shows a block diagram of a computer system according to one embodiment disclosed herein.

FIG. 3 illustrates a flowchart of a procedure performed by the system of FIG. 1 when the adaptive channel selecting process assesses channel conditions for a plurality of channels, according to one embodiment disclosed herein.

FIG. 4 illustrates a flowchart of a procedure performed by the system of FIG. 1 when the adaptive channel selecting process assesses channel conditions for a plurality of channels, and receives a request for the channel from a device during an initial phase of communication involving the device, according to one embodiment disclosed herein.

FIG. 5 illustrates a flowchart of a procedure performed by the system of FIG. 1 when the adaptive channel selecting process assesses channel conditions for a plurality of channels, and detects communications traffic for at least one channel within the plurality of channels, according to one embodiment disclosed herein.

FIG. 6 illustrates a flowchart of a procedure performed by the system of FIG. 1 when the adaptive channel selecting process maintains a history of channel information for the plurality of channels, according to one embodiment disclosed herein.

FIG. 7 illustrates a flowchart of a procedure performed by the system of FIG. 1 when the adaptive channel selecting process maintain a history of channel information for the plurality of channels, and maintains a demand history associated with a demand for communications, based on the history of channel information for the plurality of channels, according to one embodiment disclosed herein.

FIG. 8 illustrates a flowchart of a procedure performed by the system of FIG. 1 when the adaptive channel selecting process enables communications on a channel from the plurality of channels, based on the channel conditions, and the history of channel information for the plurality of channels, according to one embodiment disclosed herein.

FIG. 9 illustrates a flowchart of a procedure performed by the system of FIG. 1 when the adaptive channel selecting process enables communications on a channel from the plurality of channels, based on the channel conditions, and the history of channel information for the plurality of channels, and assesses the communications on the channel, according to one embodiment disclosed herein.

### DETAILED DESCRIPTION

Embodiments disclosed herein include methods and a computer system that perform an adaptive channel selecting process within a stationary access point. The adaptive channel selecting process dynamically adapts to in-band traffic and in-band interference conditions in, for example, a home coverage cell, based on traffic and interference signatures. Channel conditions (i.e., in-band traffic and in-band interference) are stored in a history of channel information (i.e., a historical database), along with interference signatures. The access point uses the adaptive channel selecting process to determine an optimal channel both upon startup, and at a configurable period (whether during an idle period or when a device is in use). Periodically, the adaptive channel selecting process scans a plurality of channels on the access point to identify channel conditions, and records the channel conditions within the history of channel information. In an example embodiment, the adaptive channel selecting process assesses a level of operability for at least one channel. In another example embodiment, the adaptive channel selecting process detects communications traffic and/or communications interference on at least one channel. As the adaptive channel selecting process scans the plurality of channels on the access point identifying new information, the adaptive channel selecting process updates the history of channel information.

The adaptive channel selecting process weights the interference signatures (stored within the history of channel information) interference strength that is maintained for various in-band devices and sources of in-band interference. Examples of in-band devices and sources of in-band interference include, but are not limited to 802.11b/g/n access points, Bluetooth devices, cordless phones, cordless mice, RFID tags, 802.15.4 (Zigbee) devices, PS3 and Xbox 360 console gaming controllers, TiVo DVRs, home control and monitoring devices, microwave ovens, etc. Embodiments disclosed herein reduce trouble calls due to in-band traffic, and dynamic in-band interference. Embodiments disclosed herein also provide operators with a pro-active interference reports. Interference reports notify the operators of interference levels in home coverage cells, allowing the operators to take corrective action.

The history of channel information maintains interference signatures for all operating channels for an access point. The history of channel information is dynamically updated as soon as in-band devices and sources of in-band interference are detected, for example, at a configurable interval. The adaptive channel selecting process intelligently selects an operating channel, for example, either when idle or in-call, based on current channel conditions weighted with data maintained within the history of channel information. The adaptive channel selecting process adapts to devices competing for the same channels by adaptively switching channels when detecting, for example, when a microwave and a cordless phone are attempting to operate on the same channel. In this situation, the adaptive channel selecting process switches one of the devices to a different channel that is available. The adaptive channel selecting process establishes a switching threshold at which the adaptive channel selecting process automatically switches a device to another channel. In an example embodiment, the adaptive channel selecting process notifies an operator of changing interference conditions at a subscriber location. This allows the service provider to take proactive action to ascertain the nature of interference in the home coverage cell, and to consider alternative avoidance solutions (i.e., upgrading the subscriber to beam forming, MIMO, etc, that may resist/avoid the new interference source).

In an example embodiment, the adaptive channel selecting process anticipates usage demand on a channel based on prior demand information stored within the history of channel information.

The adaptive channel selecting process assesses channel conditions for a plurality of channels, and maintains a history of channel information for the plurality of channels. The adaptive channel selecting process enables communications on a channel from the plurality of channels, based on the channel conditions, and the history of channel information for the plurality of channels. The adaptive channel selecting process provides an operator with information associated with the channel conditions and/or the history of channel conditions.

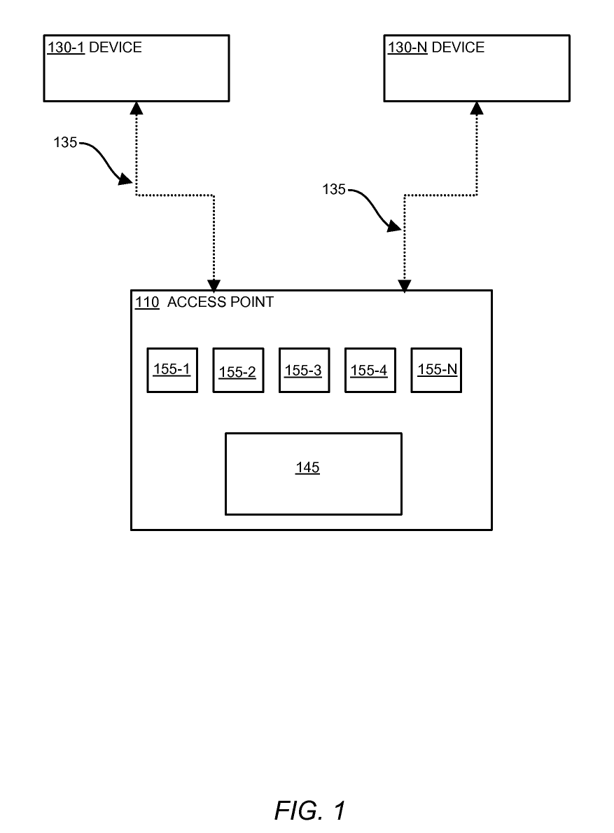

FIG. 1 is a block diagram illustrating example architecture of an access point 110 executing adaptive channel selecting process 145. The access point 110 assesses in-band traffic and in-band interference on a plurality of channels 155-N, and enables communications 135 on devices 130-N.

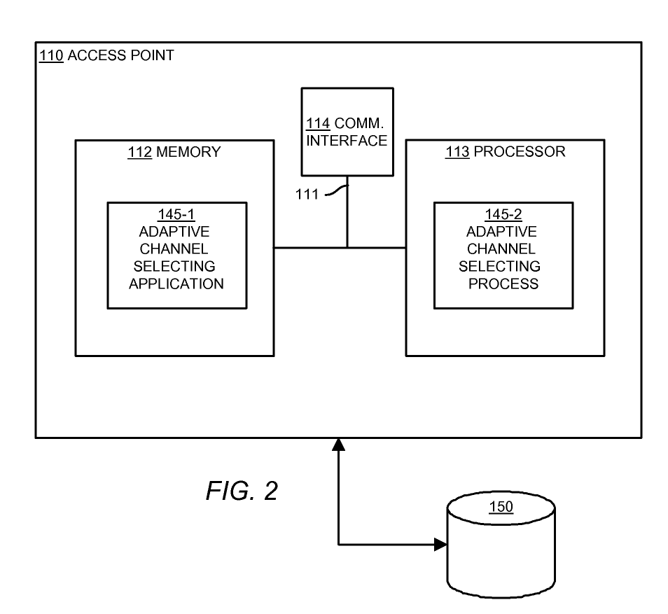

FIG. 2 illustrates an example architecture of a access point 110. The access point 110 may be any type of computerized device such as a personal computer, workstation, portable computing device, console, laptop, network terminal or the like. In this example, the access point 110 includes an interconnection mechanism 111 that couples a memory system 112, a processor 113, and a communications interface 114. The communications interface 114 enables the access point 110 to communicate with other devices (i.e., other computers) on a network (not shown). This can allow access to the adaptive channel selecting application 145-1 by remote computer systems. The channel selecting application 145-1 communicates with a history of channel information 150 to obtain channel information to adaptively select channels.

The memory system 112 may be any type of computer readable medium that is encoded with an adaptive channel selecting application 145-1 that may be embodied as software code such as data and/or logic instructions (e.g., code stored in the memory or on another computer readable medium such as a removable disk) that supports processing functionality according to different embodiments described herein. During operation of the access point 110, the processor 113 accesses the memory system 112 via the interconnect 111 in order to launch, run, execute, interpret or otherwise perform the logic instructions of the adaptive channel selecting application 145-1. Execution of the adaptive channel selecting application 145-1 in this manner produces processing functionality in an adaptive channel selecting process 145-2. In other words, the adaptive channel selecting process 145-2 represents one or more portions of runtime instances of the adaptive channel selecting application 145-1 (or the entire application 145-1) performing or executing within or upon the processor 113 in the access point 110 at runtime. It is to be understood that embodiments disclosed herein include the applications (i.e., the un-executed or non-performing logic instructions and/or data) encoded within a computer readable medium such as a floppy disk, hard disk or in an optical medium, or in a memory type system such as in firmware, read only memory (ROM), or, as in this example, as executable code within the memory system 112 (e.g., within random access memory or RAM). It is also to be understood that other embodiments disclosed herein can provide the applications operating within the processor 113 as the processes. While not shown in this example, those skilled in the art will understand that the computer system may include other processes and/or software and hardware components, such as an operating system, that have been left out of this illustration for ease of description.

Further details of configurations explained herein will now be provided with respect to a flow chart of processing steps that show the high level operations disclosed herein to perform the adaptive channel selecting process 145-2.

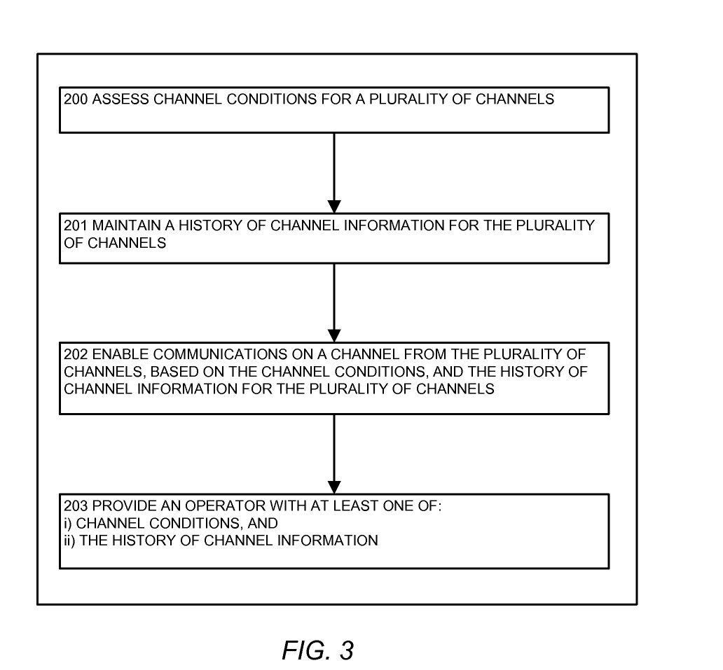

FIG. 3 is a flowchart of the steps performed by the adaptive channel selecting process 145-2 when it assesses channel conditions for a plurality of channels 155-N.

In step 200, the adaptive channel selecting process 145-2 assesses channel conditions for a plurality of channels 155-N. In an example embodiment, channel conditions may include in-band traffic, and in-band interference. For example, the in-band traffic may include devices 130-N currently in operation.

In step 201, the adaptive channel selecting process 145-2 maintains a history of channel information 150 for the plurality of channels 155-N. In an example embodiment, the history of channel information 150 is a database that includes in-band traffic, in-band interference and channel history. As the adaptive channel selecting process 145-2 detects in-band traffic and, in-band interference, the adaptive channel selecting process 145-2 updates the history of channel information 150. The history of channel information 150 provides a time based histogram (by channel 155-N) used by the adaptive channel selecting process 145-2 to select the appropriate channel for the current int.

In step 202, the adaptive channel selecting process 145-2 enables communications 135 on a channel 155-1 from the plurality of channels 155-N. The adaptive channel selecting process 145-2 enables communications 135, based on the channel conditions, and the history of channel information 150 for the plurality of channels 155-N. Thus, the adaptive channel selecting process 145-2 can adaptively select the appropriate channel 155-1 based on the history of channel information 150, and in some embodiments, the current channel conditions.

In step 203, the adaptive channel selecting process 145-2 provides an operator with at least one of:

i) channel conditions, and

ii) the history of channel information 150.

In an example embodiment, the adaptive channel selecting process 145-2 provides an operator with reports notifying the operator of changing interference conditions at a subscriber location. This allows the service provider to take proactive action to ascertain the nature of interference in the home coverage cell, and to consider alternative avoidance solutions (i.e., upgrading the subscriber to beam forming, MIMO, etc, that may resist/avoid the new interference source).

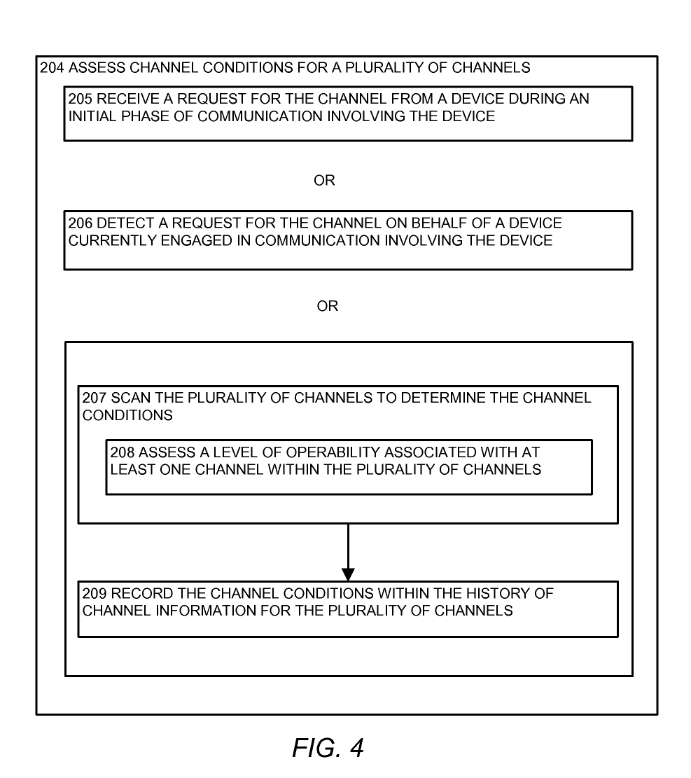

FIG. 4 is a flowchart of the steps performed by the adaptive channel selecting process 145-2 when it assesses channel conditions for a plurality of channels 155-N.

In step 204, the adaptive channel selecting process 145-2 assesses channel conditions for a plurality of channels 155-N. The adaptive channel selecting process 145-2 assesses current channel conditions when a device 130-1 requests communications 135, or during idle periods.

In step 205, the adaptive channel selecting process 145-2 receives a request for the channel 155-1 from a device 130-1 during an initial phase of communication involving the device 130-1. In an example embodiment, the device 130-1 requests a channel 155-1 when the device 130-1 attempts to establish communications 135.

Alternatively, in step 206, the adaptive channel selecting process 145-2 detects a request for the channel 155-1 on behalf of a device 130-1 currently engaged in communication involving the device 130-1. In an example embodiment, the device 130-1 is in operation, for example, a computer is downloading information from the Internet, and the adaptive channel selecting process 145-2 discovers there is too much in-band interference on the channel 155-1. The adaptive channel selecting process 145-2 requests to switch the device 130-1 (i.e., the computer) to a different channel 155-2 such that the device 130-1 (i.e., the computer) can operate without in-band interference.

Alternatively, in step 207, the adaptive channel selecting process 145-2 scans the plurality of channels 155-N to determine the channel conditions. In an example embodiment, the adaptive channel selecting process 145-2 periodically scans the plurality of channels 155-N to assess the current channel conditions. For example, the adaptive channel selecting process 145-2 may perform a scan to obtain signal to noise ratio, and to try to categorize and characterize the traffic (i.e., in-band or out-of-band).

In step 208, the adaptive channel selecting process 145-2 assesses a level of operability associated with at least one channel 155-1 within the plurality of channels 155-N. In an example embodiment, during a periodic scan of the plurality of channels 155-N, the adaptive channel selecting process 145-2 assesses the current in-band traffic and in-band interference on each of the plurality of channels 155-N.

In step 209, the adaptive channel selecting process 145-2 records the channel conditions within the history of channel information 150 for the plurality of channels 155-N. In an example embodiment, the adaptive channel selecting process 145-2 periodically scans the plurality of channels 155-N and transmits that information to the history of channel information 150. For example, a time based histogram may be created that enables the adaptive channel selecting process 145-2 to determine the demand occurring on each of the channels 155-1 from the plurality of channels 155-N during the course of a day, week, etc.

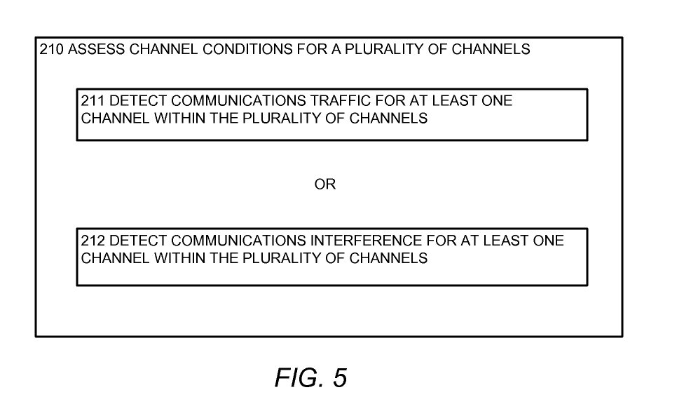

FIG. 5 is a flowchart of the steps performed by the adaptive channel selecting process 145-2 when it assesses channel conditions for a plurality of channels 155-N.

In step 210, the adaptive channel selecting process 145-2 assesses channel conditions for a plurality of channels 155-N. In an example embodiment, the channel conditions can include in-band interference, in-band traffic, etc.

In step 211, the adaptive channel selecting process 145-2 detects communications traffic for at least one channel 155-1 within the plurality of channels 155-N. For example, the adaptive channel selecting process 145-2 may determine that both a cell phone, and a microwave are in use on the same channel 155-1.

In step 212, the adaptive channel selecting process 145-2 detects communications interference for at least one channel 155-1 within the plurality of channels 155-N. In an example embodiment, the adaptive channel selecting process 145-2 detects in-band interference, and assesses the in-band interference in terms of, for example, a minor nuisance versus a major nuisance that is interfering with establish communications 135 on that channel 155-1.

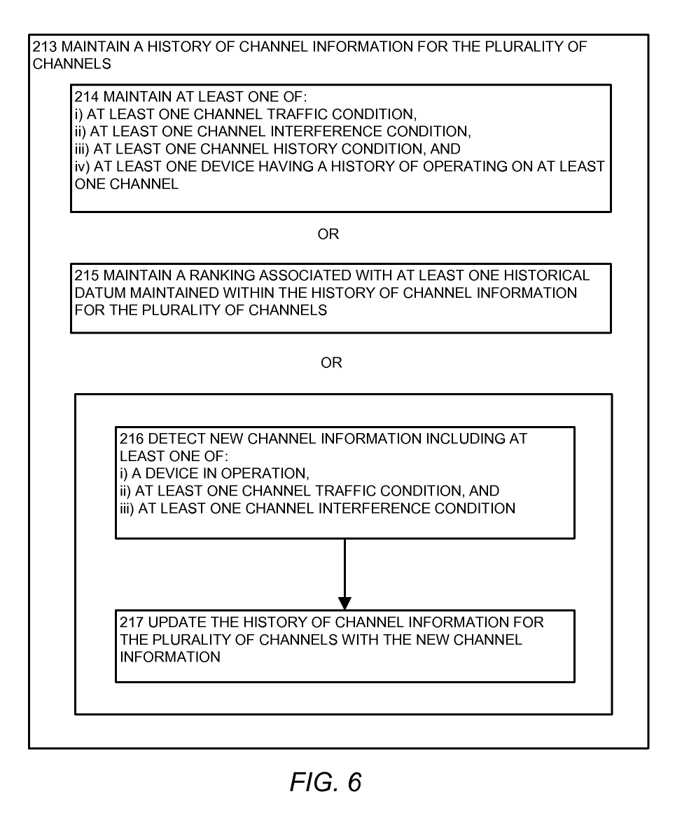

FIG. 6 is a flowchart of the steps performed by the adaptive channel selecting process 145-2 when it maintains a history of channel information 150 for the plurality of channels 155-N.

In step 213, the adaptive channel selecting process 145-2 maintains a history of channel information 150 for the plurality of channels 155-N. The history of channel information 150 is used in conjunction with the current channel conditions to select the appropriate channel 155-1 for a device 130-1. The history of channel information 150 may also be used to determine which (or what type) of device 130-1 is causing in-band interference.

In step 214, the adaptive channel selecting process 145-2 maintains at least one of:

i) at least one channel traffic condition,

ii) at least one channel interference condition,

iii) at least one channel history condition, and

iv) at least one device having a history of operating on at least one channel.

Alternatively, in step 215, the adaptive channel selecting process 145-2 maintains a ranking associated with at least one historical datum maintained within the history of channel information 150 for the plurality of channels 155-N. For example, a microwave (in operation) is likely to cause interference on a channel 155-1. The history of channel information 150 maintains a ranking associated with the interference caused by the microwave, for example, categorizing the interference as a minor nuisance or a major interference. Based on that ranking, the adaptive channel selecting process 145-2 decides whether or not to switch a device 130-1, also in operation, to another channel 155-2.

Alternatively, in step 216, the adaptive channel selecting process 145-2 detects new channel information including at least one of:
i) a device 130-1 in operation,
ii) at least one channel traffic condition, and
iii) at least one channel interference condition.

In step 217, the adaptive channel selecting process 145-2 updates the history of channel information 150 for the plurality of channels 155-N with the new channel information. As the adaptive channel selecting process 145-2 detects new channel information, the history of channel information 150 is updated with this new information. The adaptive channel selecting process 145-2 adaptively selects an appropriate channel based on the continuously updated information within the history of channel information 150.

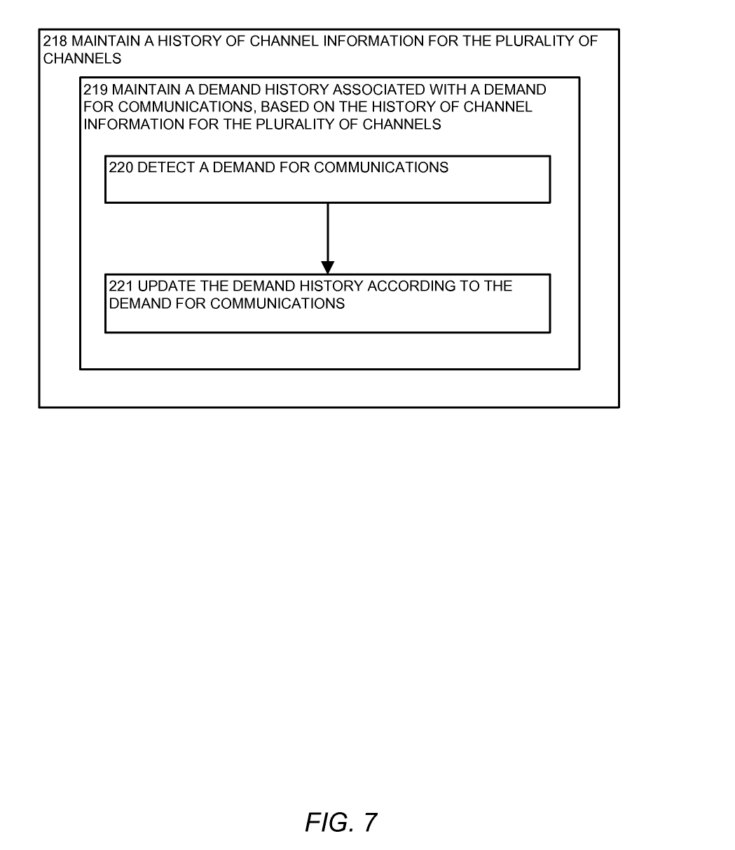

FIG. 7 is a flowchart of the steps performed by the adaptive channel selecting process 145-2 when it maintains a history of channel information 150 for the plurality of channels 155-N.

In step 218, the adaptive channel selecting process 145-2 maintains a history of channel information 150 for the plurality of channels 155-N. The history of channel information 150 is used in conjunction with the current channel conditions to select the appropriate channel for a device 130-1. The history of channel information 150 is also used to evaluate prior usage and determine (i.e., predict) future demand on the plurality of channels 155-N.

In step 219, the adaptive channel selecting process 145-2 maintains a demand history associated with a demand for communications, based on the history of channel information 150 for the plurality of channels 155-N. For example, maintaining the history of channel information 150 over twenty four hour period may reveal that there is increased channel 155-1 demand during the hours of 6 am to 8 am, then little or no channel 155-1 demand until 6 pm.

In step 220, the adaptive channel selecting process 145-2 detects a demand for communications 135. During the periodic scans by the adaptive channel selecting process 145-2, the adaptive channel selecting process 145-2 detects demand for communications 135. For example, the adaptive channel selecting process 145-2 may determine that, at 7 pm, there is large increase in demand on the plurality of channels 155-N from a microwave, a computer, and a cordless phone.

In step 221, the adaptive channel selecting process 145-2 updates the demand history according to the demand for communications. In response to detecting a demand for communications, the adaptive channel selecting process 145-2 updates the history of channel information 150 with this information. In an example embodiment, the information is used to anticipate future demand and enable communications 135 based on that anticipated demand.

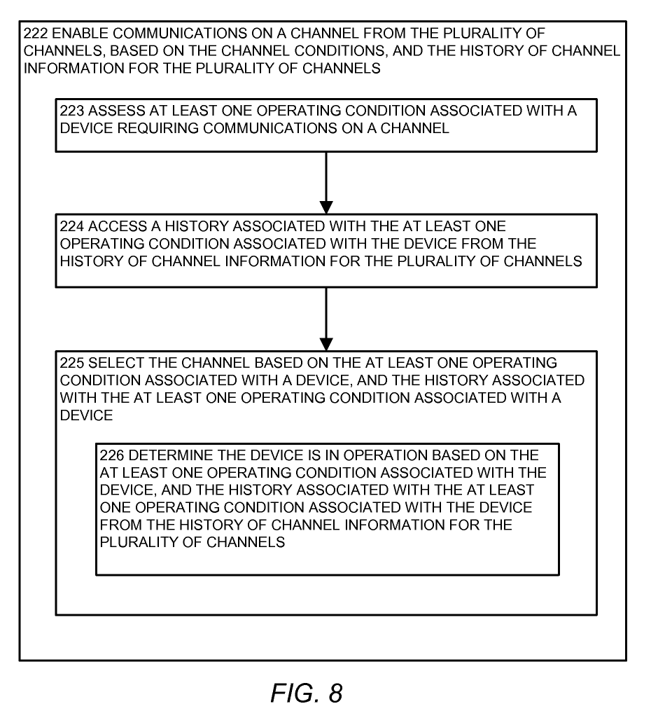

FIG. 8 is a flowchart of the steps performed by the adaptive channel selecting process 145-2 when it enables communications 135 on a channel 155-1 from the plurality of channels 155-N, based on the channel conditions, and the history of channel information 150 for the plurality of channels 155-N.

In step 222, the adaptive channel selecting process 145-2 enables communications 135 on a channel 155-1 from the plurality of channels 155-N, based on the channel conditions, and the history of channel information 150 for the plurality of channels 155-N.

In step 223, the adaptive channel selecting process 145-2 assesses at least one operating condition associated with a device 130-1 requiring communications 135 on a channel 155-1. In an example embodiment, the adaptive channel selecting process 145-2 detects in-band traffic associated with a device 130-1. For example, the adaptive channel selecting process 145-2 determines that the garage door opener has been activated.

In step 224, the adaptive channel selecting process 145-2 accesses a history associated with at least one operating condition associated with the device 130-1 from the history of channel information 150 for the plurality of channels 155-N. In an example embodiment, the adaptive channel selecting process 145-2 determines that a garage door opener has been activated. The adaptive channel selecting process 145-2 accesses the data (such as demand, usage, etc.), associated with the garage door opener, from the history of channel information 150 to determine which channel 155-N to select.

In step 225, the adaptive channel selecting process 145-2 selects the channel 155-1 based on at least one operating condition associated with a device 130-1, and the history associated with at least one operating condition associated with a device 130-1. Based on the adaptive channel selecting process's 145-2s assessment (that the garage door opener has been activated) and data in the history of channel information 150 associated with the garage door opener (i.e., the garage door opener only operates for a ten second period of time, and then ceases operation), the adaptive channel selecting process 145-2 selects the appropriate channel 155-1. For example, the adaptive channel selecting process 145-2 may select a channel 155-1 that already has in-band interference. However, because the garage door opener is only in operation for a short period of time (as provided by the history of channel information 150), the adaptive channel selecting process 145-2 determines there is no need to switch the garage door opener to a different channel 155-2.

In step 226, the adaptive channel selecting process 145-2 determines the device 130-1 is in operation based on at least one operating condition associated with the device 130-1, and the history associated with at least one operating condition associated with the device 130-1 from the history of channel information 150 for the plurality of channels 155-N. In an example embodiment, the adaptive channel selecting process 145-2 detects a device 130-1 in operation, and obtains characteristics about that device 130-1. From the history of channel information 150, the adaptive channel selecting process 145-2, using heuristics, determines that the device 130-1 in operation has the same characteristics, for example, as a microwave. The adaptive channel selecting process 145-2 determines that the device 130-1 in operation is a microwave.

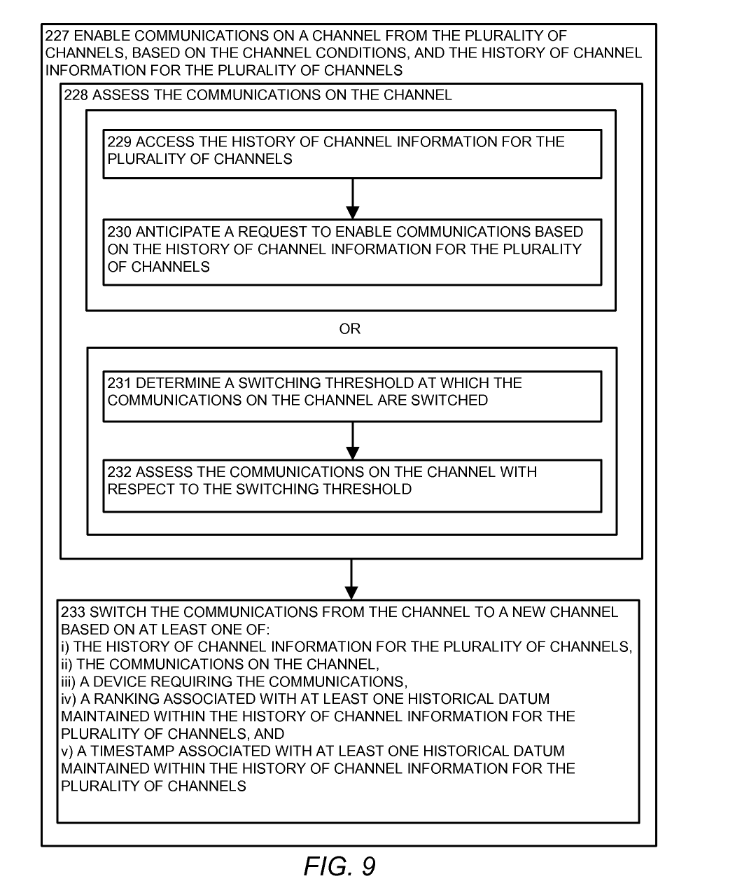

FIG. 9 is a flowchart of the steps performed by the adaptive channel selecting process 145-2 when it enable communications 135 on a channel 155-1 from the plurality of channels 155-N.

In step 227, the adaptive channel selecting process 145-2 enable communications 135 on a channel 155-1 from the plurality of channels 155-N, based on the channel conditions, and the history of channel information 150 or the plurality of channels 155-N.

In step 228, the adaptive channel selecting process 145-2 assesses the communications 135 the channel 155-1. In an example embodiment, the adaptive channel selecting process 145-2 scans the plurality of channels 155-N and assesses the communications 135 on each of the channel 155-1 from the plurality of channels 155-N.

In step 229, the adaptive channel selecting process 145-2 accesses the history of channel information 150 for the plurality of channels 155-N. In an example embodiment, the adaptive channel selecting process 145-2 accesses the history of channel information 150 via an Structured Query Language (SQL) query on the database on which the history of channel information 150 is maintained.

In step 230, the adaptive channel selecting process 145-2 anticipates a request to enable communications 135 based on the history of channel information 150 for the plurality of channels 155-N. In other words, the adaptive channel selecting process 145-2 utilizes the data in the history of channel information 150 to anticipate, or predict, the future demand on each of the channel 155-1 from the plurality of channels 155-N. For example, using the history of channel information 150, the adaptive channel selecting process 145-2 determines that the microwave is usually run at 5:00 p.m. each night. The homeowner picks up the cordless phone to make a call at 4:59 pm. Anticipating that the microwave will be started at 5:00 p.m., the adaptive channel selecting process 145-2 avoids establishing communications 135 for the cordless phone on the channel 155-3 on which the microwave is causing interference.

Alternatively, in step 231, the adaptive channel selecting process 145-2 determines a switching threshold at which the communications 135 on the channel 155-1 are switched. In an example embodiment, the adaptive channel selecting process 145-2 determines that if the in-band interference and/or in-band traffic reaches a specified level (i.e., the switching threshold), the adaptive channel selecting process 145-2 will switch to a different channel 155-4.

In step 232, the adaptive channel selecting process 145-2 assesses the communications 135 on the channel 155-3 with respect to the switching threshold. In an example embodiment, as the adaptive channel selecting process 145-2 periodically scans the channel 155-1 from the plurality of channels 155-N, the adaptive channel selecting process 145-2 assesses if the in-band interference and in-band traffic on any of the channels 155-N has reached the switching threshold. If so, the adaptive channel selecting process 145-2 then switches channels 155-N.

In step 233, the adaptive channel selecting process 145-2 switches the communications 135 from the channel 155-1 to a new channel 155-2 based on at least one of:
i) the history of channel information 150 for the plurality of channels 155-N,
ii) the communications 135 on the channel 155-1,
iii) a device 130-1 requiring the communications 135,
iv) a ranking associated with at least one historical datum maintained within the history of channel information 150 for the plurality of channels 155-N, and
v) a timestamp associated with at least one historical datum maintained within the history of channel information 150 for the plurality of channels 155-N.

In an example embodiment, the adaptive channel selecting process 145-2 uses the type of device 130-1 as the basis for the decision to switch. For example, if the device 130-1 is a microwave, the adaptive channel selecting process 145-2 may decide to switch to another channel 155-1. If the device 130-1 is a garage door opener, the adaptive channel selecting process 145-2 may decide not to switch.

While computer systems and methods have been particularly shown and described above with references to configurations thereof, it will be understood by those skilled in the art that various changes in form and details may be made therein without departing from the scope disclosed herein. Accordingly, embodiments disclosed herein are not intended to be limited by the example configurations provided above.

What is claimed is:

1. A method of enabling communications, the method comprising:
assessing channel conditions for a plurality of channels;
maintaining a history of channel information for the plurality of channels; and
enabling communications on a channel from the plurality of channels, based on the channel conditions, and the history of channel information for the plurality of channels.

2. The method of claim 1 comprising:
providing an operator with at least one of:
i) channel conditions; and
ii) the history of channel information.

3. The method of claim 1 wherein assessing channel conditions for a plurality of channels comprises:
receiving a request for the channel from a device during an initial phase of communication involving the device.

4. The method of claim 1 wherein assessing channel conditions for a plurality of channels comprises:
detecting a request for the channel on behalf of a device currently engaged in communication involving the device.

5. The method of claim 1 wherein assessing channel conditions for a plurality of channels comprises:
scanning the plurality of channels to determine the channel conditions; and
recording the channel conditions within the history of channel information for the plurality of channels.

6. The method of claim 5 wherein scanning the plurality of channels to determine the channel conditions comprises:
assessing a level of operability associated with at least one channel within the plurality of channels.

7. The method of claim 1 wherein assessing channel conditions for a plurality of channels comprises:
detecting communications traffic for at least one channel within the plurality of channels.

8. The method of claim 1 wherein assessing channel conditions for a plurality of channels comprises:
detecting communications interference for at least one channel within the plurality of channels.

9. The method of claim 1 wherein maintaining a history of channel information for the plurality of channels comprises:
maintaining at least one of:
i) at least one channel traffic condition;
ii) at least one channel interference condition;
iii) at least one channel history condition; and
iv) at least one device having a history of operating on at least one channel.

10. The method of claim 1 wherein maintaining a history of channel information for the plurality of channels comprises:
maintaining a ranking associated with at least one historical datum maintained within the history of channel information for the plurality of channels.

11. The method of claim 1 wherein maintaining a history of channel information for the plurality of channels comprises:
detecting new channel information including at least one of:
i) a device in operation;
ii) at least one channel traffic condition; and
iii) at least one channel interference condition; and
updating the history of channel information for the plurality of channels with the new channel information.

12. The method of claim 1 wherein maintaining a history of channel information for the plurality of channels comprises:
maintaining a demand history associated with a demand for communications, based on the history of channel information for the plurality of channels.

13. The method of claim 12 wherein maintaining a demand history associated with a demand for communications, based on the history of channel information for the plurality of channels comprises:
detecting a demand for communications; and
updating the demand history according to the demand for communications.

14. The method of claim 1 wherein enabling communications on a channel from the plurality of channels, based on the channel conditions, and the history of channel information for the plurality of channels comprises:
assessing at least one operating condition associated with a device requiring communications on a channel;
accessing a history associated with the at least one operating condition associated with the device from the history of channel information for the plurality of channels; and
selecting the channel based on the at least one operating condition associated with a device, and the history associated with the at least one operating condition associated with a device.

15. The method of claim 14 wherein selecting the channel based on the at least one operating condition associated with a device, and the history associated with the at least one operating condition associated with a device comprises:
determining the device is in operation based on the at least one operating condition associated with the device, and the history associated with the at least one operating condition associated with the device from the history of channel information for the plurality of channels.

16. The method of claim 1 wherein enabling communications on a channel from the plurality of channels, based on the channel conditions, and the history of channel information for the plurality of channels comprises:
assessing the communications on the channel;
switching the communications from the channel to a new channel based on at least one of:
i) the history of channel information for the plurality of channels;
ii) the communications on the channel;
iii) a device requiring the communications;
iv) a ranking associated with at least one historical datum maintained within the history of channel information for the plurality of channels; and
v) a timestamp associated with at least one historical datum maintained within the history of channel information for the plurality of channels.

17. The method of claim 16 wherein assessing the communications on the channel comprises:
accessing the history of channel information for the plurality of channels; and
anticipating a request to enable communications based on the history of channel information for the plurality of channels.

18. The method of claim 16 wherein assessing the communications on the channel comprises:
determining a switching threshold at which the communications on the channel are switched; and
assessing the communications on the channel with respect to the switching threshold.

19. A computerized device comprising:
a memory;
a processor;
a communications interface;
an interconnection mechanism coupling the memory, the processor and the communications interface;
wherein the memory is encoded with an adaptive channel selecting application that when executed on the processor is capable of selecting a channel on the computerized device by performing the operations of:
assessing channel conditions for a plurality of channels;
maintaining a history of channel information for the plurality of channels; and
enabling communications on a channel from the plurality of channels, based on the channel conditions, and the history of channel information for the plurality of channels.

20. A computer readable medium encoded with computer programming logic that when executed on a process in a computerized device selects a channel, the medium comprising:
instructions for assessing channel conditions for a plurality of channels;
instructions for maintaining a history of channel information for the plurality of channels; and
instructions for enabling communications on a channel from the plurality of channels, based on the channel conditions, and the history of channel information for the plurality of channels.
